(19) United States
(12) Patent Application Publication
(10) Pub. No.: US 2011/0187658 A1
(43) Pub. Date: Aug. 4, 2011

(54) TOUCH SCREEN DEVICE

(75) Inventors: Jong Hyeong Song, Gyunggi-do (KR); Seung Do An, Gyunggi-do (KR); Jong Woo Han, Gyunggi-do (KR); Hae Seung Hyun, Gyunggi-do (KR); Kyungno Lee, Seoul (KR)

(73) Assignee: SAMSUNG ELECTRO-MECHANICS CO., LTD., Gyunggi-do (KR)

(21) Appl. No.: 12/960,385

(22) Filed: Dec. 3, 2010

(30) Foreign Application Priority Data
Jan. 29, 2010 (KR) 102010008521

(51) Int. Cl. G06F 3/041

(52) U.S. Cl. 345/173

(57) ABSTRACT

Disclosed herein is a touch screen device 100a, including: a touch screen 110, and actuators 120a, 120b, and 120c that drive the touch screen 110 in two dimensions including an up and down direction or in three dimensions. The touch screen device 100a can be driven in an up and down direction vertical to the touch screen, thereby making it possible to transfer a realistic touch sense such as a click sense, a dialing sense, and a surface texture sense to a user.

### CROSS REFERENCE TO RELATED APPLICATION

This application claims the benefit of Korean Patent Application No. 10-2010-0008521, filed on Jan. 29, 2010, entitled “Touch screen device”, which is hereby incorporated by reference in its entirety into this application.

### BACKGROUND OF THE INVENTION

1. Technical Field

The present invention relates to touch screen device.

2. Description of the Related Art

With the recent demands by users requesting for simply using electronic products, a touch screen that inputs instructions by touching the electronic product has been widely used. The touch screen device has various advantages such as being very compatible with IT devices in addition to being simply operated in a small space, specifications can be easily changed, and high in a user recognition. Owing to these advantages, the touch screen device is widely used in various fields such as industrial, traffic, service, medicine, mobile, and the like.

In recent years, research of a touch panel providing haptic feedback, which is one kind of tactile feedback, has actively progressed in order to improve a signal transmission effect of the touch panel to a user. In general, the haptic feedback uses an eccentric rotating mass (ERM) motor or an electromagnetic motor that generates vibration when rotation is unbalanced while rotating by directionally configuring a weight center of a rotor to be eccentric.

Meanwhile, the haptic feedback may use a piezo actuator besides the eccentric rotating mass (ERM) motor or the electromagnetic motor, wherein the piezo actuator means an actuator driven by using the piezoelectric phenomenon of a piezoelectric material. When pressure is applied to crystals such as crystal, rochell salt, or the like, voltage is generated, which is referred to as a piezoelectric direct effect. To the contrary, when voltage is applied to crystals, the crystals are modified, which is referred to as a piezoelectric converse effect. The piezo actuator may generate vibration by using such a piezoelectric converse effect and can be driven with large torque, small noise, and small driving power as compared to the motor according to the prior art.

The vibrating feedback using the ERM motor, the electromagnetic motor, or the piezo actuator according to the prior art, however, vibrates on parallel planes of a touch screen panel in one dimension or in two dimensions. Therefore, there is a limitation in transferring a realistic touch sense that can be transferred by stimulating the skin surface of a user. In particular, there is a limitation in implementing a click sense giving vibration or resistance when a button is pressed, a drag sense giving a feel if an object moves along at the time of pushing and moving an object, roughness felt at the time of touching the surface, a texture sense giving a surface texture such as a fine shape, etc., and, as a result, user operability is deteriorated.

### SUMMARY OF THE INVENTION

The present invention has been made an effort to provide a touch screen device that can enhance user operability by improving a touch sense such as a click sense, a drag sense, a texture sense, and the like.

A touch screen device according to a first preferred embodiment of the present invention includes: a touch screen; a first actuator that drives the touch screen in an up and down direction (a Z direction); and a second actuator that is selected from an X-axis actuator driving the touch screen in a right and left direction (an X direction) and a Y-axis actuator driving the touch screen in a forward and backward direction (a Y direction).

Herein, the first actuator repeats the process of separating the touch screen from an input unit by driving the touch screen downward and the process of contacting the touch screen to the input unit by driving the touch screen upward.

Further, the first actuator controls the ratio of a contact time and a separation time between the touch screen and the input unit to control friction force between the touch screen and the input unit.

Further, the frequency, the amplitude, or the frequency and amplitude may be different between when the first actuator drives the touch screen upward and when the first actuator drives the touch screen downward.

Further, when the first actuator drives the touch screen upward, the X-axis actuator drives the touch screen in one direction of the right and left direction (the X direction) and when the first actuator drives the touch screen downward, the X-axis actuator drives the touch screen in the other direction of the right and left direction (the X direction).

Further, when the first actuator drives the touch screen upward, the Y-axis actuator drives the touch screen in one direction of the forward and backward direction (the Y direction) and when the first actuator drives the touch screen downward, the Y-axis actuator drives the touch screen in the other direction of the forward and backward direction (the Y direction).

Further, the first actuator is provided at the bottom surface of the touch screen, the X-axis actuator is provided at the left surface, the right surface, the right and left surfaces, or the bottom surface of the touch screen, and the Y-axis actuator is provided at the front surface, the rear surface, the front and rear surfaces, or the bottom surface of the touch screen.

Further, a first driving signal applied to the first actuator has a different phase, amplitude, or phase and amplitude from that of a second driving signal applied to the second actuator.

Further, the touch screen is driven in an oblique, circular or oval form depending on the phase difference between the first driving signal and the second driving signal.

A touch screen device according to a second preferred embodiment of the present invention includes: a touch screen; a first actuator that drives the touch screen in an up and down direction (an Z direction); a second actuator that drives the touch screen in a right and left direction (an X direction); and a third actuator that drives the touch screen in a forward and backward direction (a Y direction).

Herein, the first actuator repeats the process of separating the touch screen from an input unit by driving the touch screen downward and the process of contacting the touch screen to the input unit by driving the touch screen upward.

Further, the first actuator controls the ratio of a contact time and a separation time between the touch screen and the input unit to control friction force between the touch screen and the input unit.

Further, the frequency, the amplitude, or the frequency and amplitude is different between when the first actuator drives the touch screen upward and when the first actuator drives the touch screen downward.

Further, when the first actuator drives the touch screen upward, the second actuator drives the touch screen in one direction of the right and left direction (the X direction) and when the first actuator drives the touch screen downward, the second actuator drives the touch screen in the other direction of the right and left direction (the X direction).

Further, when the first actuator drives the touch screen upward, the third actuator drives the touch screen in one direction of the forward and backward direction (the Y direction) and when the first actuator drives the touch screen downward, the third actuator drives the touch screen in the other direction of the forward and backward direction (the Y direction).

Further, the first actuator is provided at the bottom surface of the touch screen, the second actuator is provided at the left surface, the right surface, the right and left surfaces, or the bottom surface of the touch screen, and the third actuator is provided at the front surface, the rear surface, the front and rear surfaces, or the bottom surface of the touch screen.

Further, a first driving signal applied to the first actuator has a different phase, amplitude, or phase and amplitude from that of a second driving signal applied to the second actuator or a third driving signal applied to the third actuator.

Further, the touch screen is driven in an oblique, circular or oval form depending on the phase difference between the first driving signal and the second driving signal or between the first driving signal and the third driving signal.

### BRIEF DESCRIPTION OF THE DRAWINGS

FIG. 1 is a schematic cross-sectional view of a touch screen device according to a preferred first embodiment of the present invention;

FIG. 2 is a diagram for explaining a generating principle of a touch sense of the touch screen device of FIG. 1;

FIG. 3 is a diagram for explaining an applied example of the generating principle of a drag sense of the touch screen device of FIG. 1;

FIG. 4 is a diagram for explaining an applied example of the generating principle of a texture sense of the touch screen device of FIG. 1;

FIG. 5 is a diagram showing waveforms of driving signals applied to the actuator of FIG. 1; and

FIG. 6 is a schematic cross-sectional view of a touch screen device according to a preferred second embodiment of the present invention.

### DESCRIPTION OF THE PREFERRED EMBODIMENTS

Various objects, advantages and features of the invention will become apparent from the following description of the embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

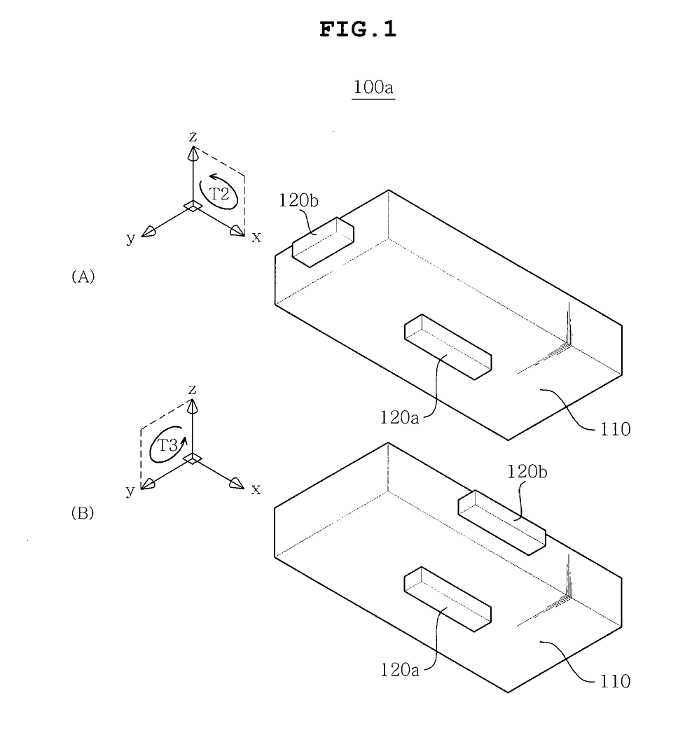

FIG. 1 is a schematic cross-sectional view of a touch screen device according to a preferred first embodiment of the present invention. Hereinafter, a touch screen device 100a according to the present embodiment will be described with reference to the figure.

As shown in FIG. 1, the touch screen device 100a according to the present embodiment is configured to include a touch screen 110, and actuators 120a and 120b that drive the touch screen 110 in two dimensions including an up and down direction.

The touch screen 110 is a unit that inputs and displays a user's command by pressing and operating a touch panel, while seeing an image displayed on an image display unit. The touch screen 110 is configured to include an image display unit and a touch panel. Herein, the touch panel has transparency and flexibility and functions as an input signal surface to be pressed so as to operate, while seeing the image displayed on the image display unit. The touch panel has, for example, a structure in which an indium tin oxide (ITO) film layer and is an external film layer functioning as a touch surface are stacked on a base film layer performing a support function.

The actuators 120a and 120b generate vibration to apply vibration to the touch screen 110. The actuators 120a and 120b generate driving force to drive the touch screen 110 in two dimensions including an up and down direction so that a touch sense can be improved. In other words, the present embodiment generates a vibration feedback that vibrates the touch screen 110 in an up and down direction, that is, in two dimensions rather than a vibration feedback that vibrates the touch screen 110 in one direction, that is, in one dimension, thereby providing an improved touch sense to a user.

Herein, in order to generate the driving force in two dimensions including an up and down direction, the actuators 120a and 120b are formed of the first actuator 120a that drives the touch screen 110 in an Z direction and the second actuator 120b that drives the touch screen 110 in one direction selected from X and Y directions.

In other words, the first actuator 120a is an Z-axis actuator that applies a driving force driving the touch screen 110 in an up and down direction (an Z direction), and the second actuator 120b is one actuator selected from an X-axis actuator that applies a driving force driving the touch screen 110 in a right and left direction (an X direction) and a Y-axis actuator that applies a driving force driving the touch screen 110 in a forward and backward direction (a Y direction). At this time, the X-axis actuator is provided at the left surface, the right surface, the left and right surfaces or the bottom surface of the touch screen 110 to apply vibration to the touch screen 110 in the X-axis direction, the Y-axis actuator is provided at the front surface, the rear surface, the front and rear surfaces, or the bottom surface of the touch screen 110 to apply vibration to the touch screen 110 in the Y-axis direction, and the Z-axis actuator is provided at the bottom surface of the touch screen 110 to apply vibration to the touch screen 110 in the Z-axis direction.

FIG. 1A shows the touch screen device that includes the first actuator 120a formed of the Z-axis actuator and the second actuator 120b formed of the X-axis actuator. In this case, the vibratory force generated from the first actuator 120a and the second actuator 120b applies the two dimensional driving force to the touch screen 110 in the X and Z directions, such that the touch screen 110 is driven on the XZ plane in the driving direction such as T2 (for example, in an oblique, circular, or oval shaped driving direction).

FIG. 1B shows the touch screen device that includes the first actuator 120a formed of the Z-axis actuator and the second actuator 120b formed of the Y-axis actuator. In this case, the vibratory force generated from the first actuator 120a and the second actuator 120b applies the two dimensional driving force to the touch screen 110 in the Y and Z directions, such that the touch screen 110 is driven on the YZ plane in the driving direction such as T3 (for example, in an oblique, circular, or oval shaped driving direction).

Therefore, the touch screen device 100a according to the present embodiment drives the touch screen in the up and down direction, thereby making it possible to transfer a click sense, a dialing sense, and a real touch sense such as a surface texture to the user. The detailed description thereof will be described below.

Meanwhile, as the actuators 120a and 120b, a piezo (or polymer) actuator or a linear vibration motor that contracts or expands by external power in a longitudinal direction to apply vibratory sensation may be used.

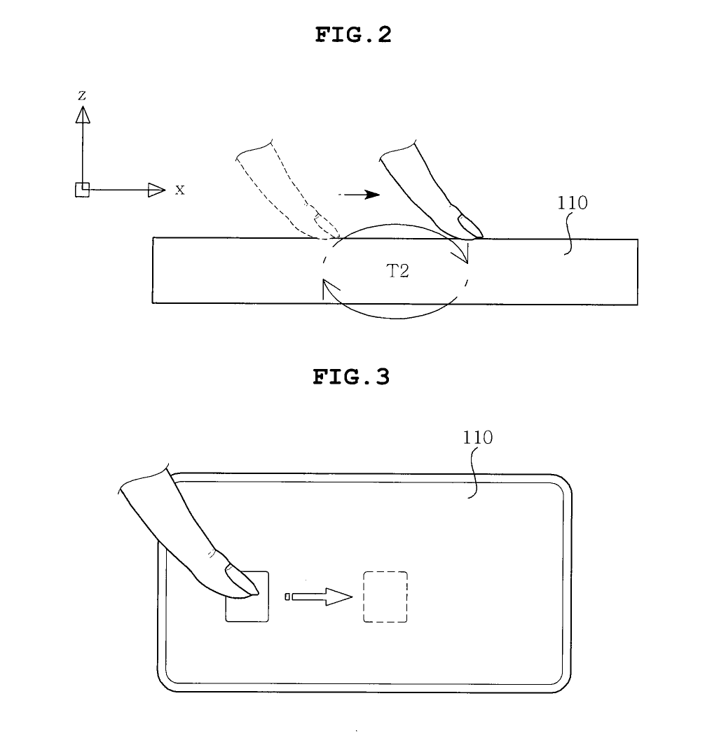

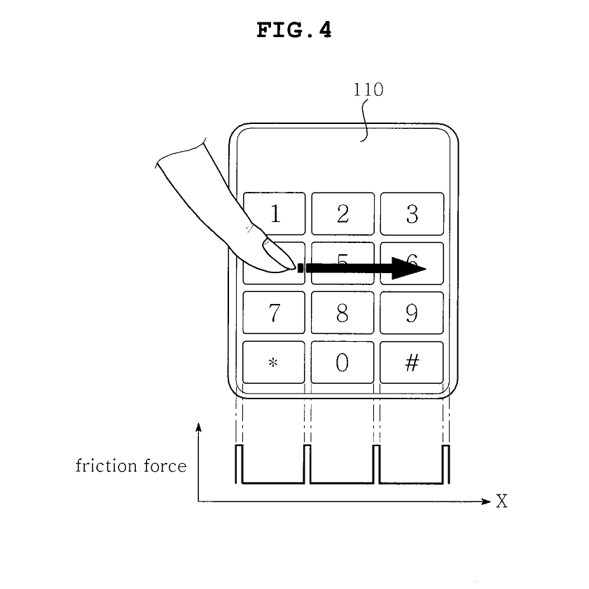

FIG. 2 is a diagram for explaining a generating principle of a touch sense of the touch screen device of FIG. 1, FIG. 3 is a diagram for explaining an applied example of the generating principle of a drag sense of the touch screen device of FIG. 1, and FIG. 4 is a diagram for explaining an applied example of the generating principle of a texture sense of the touch screen device of FIG. 1.

Hereinafter, the principle of improving a touch sense when the touch screen is driven in two dimensions will be described with reference to the figures. Meanwhile, FIG. 2 shows a state in which the touch screen 110 is driven on the XZ plane shown in FIG. 1A in two dimensions by way of example and the touch screen 110 may also be driven on the YZ plane in the same principle.

As shown in FIG. 2, when a user touches the touch screen 110 using an input unit (user's fingers, etc.), the touch screen 110 driven in an oval form on the XZ plane in the driving direction such as T2 vibrates together with the user's fingers. More specifically, when the first actuator 120a drives the touch screen 110 upward, the X-axis actuator 120b drives the touch screen 110 in one direction of the right and left direction (the X direction), and when the first actuator 120a drives the touch screen 110 downward, the X-axis actuator 120b drives the touch screen 110 in the other direction of the right and left direction (the X direction). At this time, the input unit (user's fingers, etc.) feels the movement of the touch screen 110, thereby making it possible to transfer excellent touch sense.

In the processes as described above, if the process that the touch screen 110 is separate from the input unit when the first actuator 120a drives the touch screen 110 downward and the process that the touch screen 110 contacts the input unit when the first actuator 120a drives the touch screen 110 upward are repeated, a user feels as if the touch screen 110 actually moves along one direction of the right and left direction (the X direction) through the input unit. Therefore, when the user moves the input unit on the touch screen 110 in one direction, the touch screen device 100a recognizes it and drives the touch screen 110 in the method as described above, such that the user can feel a drag sense (feeling as if an object moves accordingly when pushing and moving the object).

For example, as shown in FIG. 3, when moving an icon on the touch screen 110, the user senses, using the input unit, as if the panel moves in the direction that the icon moves, which is subsequently recognized as if the icon is dragged.

In addition, the first actuator 120a controls the contact time and the separation time, while repeating the process of separating the touch screen 110 from the input unit by driving the touch screen 110 downward and the process of contacting the touch screen 110 to the input unit by driving the touch screen 110 upward, such that a user may feel a texture sense giving a surface texture such as a fine shape, etc.

Hereinafter, the process of implementing the texture sense will be described in more detail.

In consideration of an equation, friction force F=μN T (μ: friction coefficient, N: normal force, T: contact time/(contact time+separation time)), T is a variation affected by the contact time and the separation time between the touch screen 110 and the input unit. As a result, the friction force between the touch screen 110 and the input unit can be controlled by controlling the ratio of the contact time and the separation time. In this manner, different friction force may be provided on the touch screen 110 depending on the position of the input unit and a user may feel the texture sense therethrough.

For example, as shown in FIG. 4, when the input unit moves along the touch screen 110, on the icons the ratio of the separation time between the input unit and the touch screen 110 increases to lower the friction force, and on the interface of the icons the ratio of the contact time between the input unit and the touch screen 110 increases to raise the friction force, such that a user can feel a texture sense through the difference in friction force.

Meanwhile, when the first actuator 120a drives the touch screen 110 in the up and down direction, the touch screen 110 and the input unit do not always need to repeat the contact and the separation. Even while the touch screen 110 is driven downward and is in contact with the input unit, it is possible to implement the touch sense, as needed.

For example, the frequency, the amplitude, or the frequency and amplitude is different between when the first actuator 120a drives the touch screen 110 upward and when the first actuator 120a drives the touch screen 110 downward, thereby making it possible to implement a click sense giving vibration or resistance felt when pressing a button.

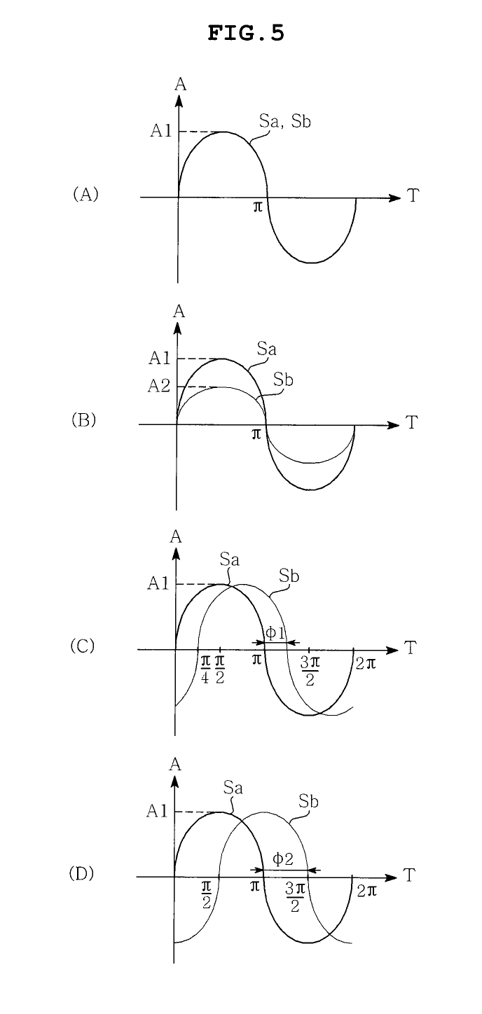

FIG. 5 is a diagram showing waveforms of driving signals applied to the actuator of FIG. 1. Hereinafter, the driving direction of the touch screen according to the waveforms of the driving signals applied to the actuator will be described with reference to the figure.

As shown in FIG. 5, a first driving signal Sa applied to the first actuator 120a and a second driving signal Sb applied to the second actuator 120b may have the same or different phases and amplitudes. For example, a sinusoidal driving signal having the same phase and the same amplitude A1 (see FIG. 5A), a driving signal having different amplitudes A1≠A2 (see FIG. 5B), or a driving signal having different phases Φ1 and Φ2 (see FIGS. 5C and D) may be applied. Although not shown, a driving signal having different phases and amplitudes may also be applied.

The amplitudes and the phases of the driving signals Sa and Sb are controlled as described above, such that the touch screen 110 is driven in various driving directions. For example, when the first driving signal Sa and the second driving signal Sb have the same phase (see FIGS. 5A and B), the touch screen 110 is driven in an oblique direction, when the first driving signal Sa and the second driving signal Sb have the phase difference Φ1 of π/4 (see FIG. 5C), the touch screen 110 is driven in a circular form, and when the first driving signal Sa and the second driving signal Sb have the phase difference Φ2 of π/2 (see FIG. 5D), the touch screen 110 is driven in a oval form.

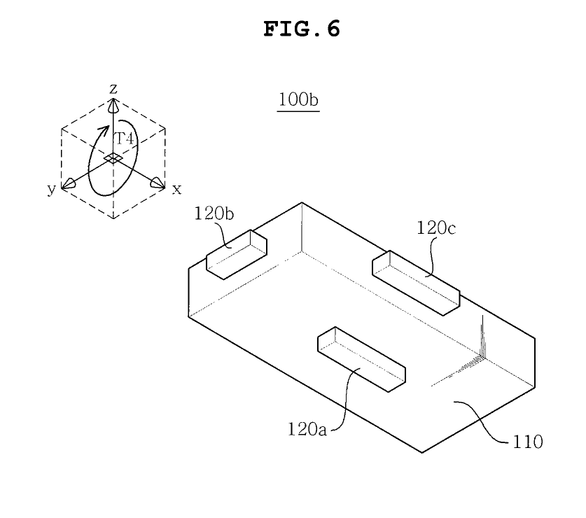

FIG. 6 is a schematic cross-sectional view of a touch screen device according to a preferred second embodiment of the present invention. Hereinafter, a touch screen device 100b according to the present embodiment will be described with reference to these drawings.

As shown in FIG. 6, the touch screen device 100b according to the present embodiment is configured to include a touch screen 110, and actuators 120a, 120b, and 120c that drive the touch screen 110 in three dimensions.

Herein, in order to generate three dimensional driving force, the actuators 120a, 120b, and 120c are configured to include three actuators that apply vibration in Z, X, and Y directions in order to generate driving force in three dimensions. More specifically, the actuators 120a, 120b, and 120c are configured to include a Z-axis actuator (a first actuator 120a) that applies driving force driving the touch screen in an up and down direction (a Z direction), an X-axis actuator (a second actuator 120b) that applies driving force driving the touch screen 110 in a right and left direction (an X direction), and a Y-axis actuator (a third actuator 120c) that applies driving force driving the touch screen 110 in a forward and backward direction (a Y direction).

At this time, the vibratory force generated from the first to third actuators 120a, 120b, and 120c apply a three dimensional driving force to the touch screen 110 in the Z, Y and X directions, such that the touch screen 110 is driven on the XYZ planes in the driving direction such as T4 (for example, in a circular or oval shaped driving direction).

Meanwhile, although not shown, the first to third actuators 120a, 120b, and 120c may be applied with the driving signals having differences in the phase, the amplitude, or the phase and the amplitude, such that the touch screen 110 is driven in various driving directions T4. In addition, a touch sense such as a click sense, a drag sense, a texture sense, and the like may also be implemented through the same driving process as that of the touch screen device 100a according to the first embodiment.

According to the present invention, the touch screen is driven in two dimensions including an up and down direction or in three dimensions to improve a touch sense, thereby making it possible to enhance user operability.

In addition, according to the present invention, the amplitude, the phase, and the like of the driving signals applied to the actuators that generate vibrations to the touch screen in X-axis, Y-axis, and Z-axis directions are controlled, such that the touch screen can be driven in various driving forms. In particular, the touch screen device can be driven in the up and down direction vertical to the touch screen, thereby making it possible to transfer a real touch sense such as a click sense, a dialing sense, and a surface texture sense to a user.

Although the preferred embodiments of the present invention have been disclosed for illustrative purposes, they are for specifically explaining the present invention and thus the touch screen device according to the present invention is not limited thereto, but those skilled in the art will appreciate that various modifications, additions and substitutions are possible, without departing from the scope and spirit of the invention as disclosed in the accompanying claims.

Accordingly, such modifications, additions and substitutions should also be understood to fall within the scope of the present invention.

What is claimed is:

1. A touch screen device, comprising:
a touch screen;
a first actuator that drives the touch screen in an up and down direction (a Z direction); and
a second actuator that is selected from an X-axis actuator driving the touch screen in a right and left direction (an X direction) and a Y-axis actuator driving the touch screen in a forward and backward direction (a Y direction).

2. The touch screen device as set forth in claim 1, wherein the first actuator repeats the process of separating the touch screen from an input unit by driving the touch screen downward and the process of contacting the touch screen to the input unit by driving the touch screen upward.

3. The touch screen device as set forth in claim 2, wherein the first actuator controls the ratio of a contact time and a separation time between the touch screen and the input unit to control friction force between the touch screen and the input unit.

4. The touch screen device as set forth in claim 1, wherein the frequency, the amplitude, or the frequency and amplitude is different between when the first actuator drives the touch screen upward and when the first actuator drives the touch screen downward.

5. The touch screen device as set forth in claim 1, wherein when the first actuator drives the touch screen upward, the X-axis actuator drives the touch screen in one direction of the right and left direction (the X direction) and when the first actuator drives the touch screen downward, the X-axis actuator drives the touch screen in the other direction of the right and left direction (the X direction).

6. The touch screen device as set forth in claim 1, wherein when the first actuator drives the touch screen upward, the Y-axis actuator drives the touch screen in one direction of the forward and backward direction (the Y direction) and when the first actuator drives the touch screen downward, the Y-axis actuator drives the touch screen in the other direction of the forward and backward direction (the Y direction).

7. The touch screen device as set forth in claim 1, wherein the first actuator is provided at the bottom surface of the touch screen, the X-axis actuator is provided at the left surface, the right surface, the right and left surfaces, or the bottom surface of the touch screen, and the Y-axis actuator is provided at the front surface, the rear surface, the front and rear surfaces, or the bottom surface of the touch screen.

8. The touch screen device as set forth in claim 1, wherein a first driving signal applied to the first actuator has a different phase, amplitude, or phase and amplitude from that of a second driving signal applied to the second actuator.

9. The touch screen device as set forth in claim 8, wherein the touch screen is driven in an oblique, circular or oval form depending on the phase difference between the first driving signal and the second driving signal.

10. A touch screen device, comprising:
a touch screen;
a first actuator that drives the touch screen in an up and down direction (an Z direction);
a second actuator that drives the touch screen in a right and left direction (an X direction); and
a third actuator that drives the touch screen in a forward and backward direction (a Y direction).

11. The touch screen device as set forth in claim 10, wherein the first actuator repeats the process of separating the touch screen from an input unit by driving the touch screen downward and the process of contacting the touch screen to the input unit by driving the touch screen upward.

12. The touch screen device as set forth in claim 11, wherein the first actuator controls the ratio of a contact time and a separation time between the touch screen and the input unit to control friction force between the touch screen and the input unit.

13. The touch screen device as set forth in claim 10, wherein the frequency, the amplitude, or the frequency and amplitude is different between when the first actuator drives the touch screen upward and when the first actuator drives the touch screen downward.

14. The touch screen device as set forth in claim 10, wherein when the first actuator drives the touch screen upward, the second actuator drives the touch screen in one direction of the right and left direction (the X direction) and when the first actuator drives the touch screen downward, the second actuator drives the touch screen in the other direction of the right and left direction (the X direction).

15. The touch screen device as set forth in claim 10, wherein when the first actuator drives the touch screen upward, the third actuator drives the touch screen in one direction of the forward and backward direction (the Y direction) and when the first actuator drives the touch screen downward, the third actuator drives the touch screen in the other direction of the forward and backward direction (the Y direction).

16. The touch screen device as set forth in claim 10, wherein the first actuator is provided at the bottom surface of the touch screen, the second actuator is provided at the left surface, the right surface, the right and left surfaces, or the bottom surface of the touch screen, and the third actuator is provided at the front surface, the rear surface, the front and rear surfaces, or the bottom surface of the touch screen.

17. The touch screen device as set forth in claim 10, wherein a first driving signal applied to the first actuator has a different phase, amplitude, or phase and amplitude from that of a second driving signal applied to the second actuator or a third driving signal applied to the third actuator.

18. The touch screen device as set forth in claim 17, wherein the touch screen is driven in an oblique, circular or oval form depending on the phase difference between the first driving signal and the second driving signal or between the first driving signal and the third driving signal.
